(19) United States
(12) Patent Application Publication
(10) Pub. No.: US 2023/0292784 A1
(43) Pub. Date: Sep. 21, 2023

(54) A NON-BAKED FOOD PRODUCT COMPRISING A CHOCOLATE NOUGAT COMPOSITION

(71) Applicant: MARS, INCORPORATED, McLean, VA (US)

(72) Inventors: Linda HUIJS, Chicago, IL (US); Susie DONNELLY, Chicago, IL (US); Peter VAN DEURZEN, Chicago, IL (US); Theodor PRINSEN, Chicago, IL (US); Raymond LITTLE, Chicago, IL (US); Hans VAN HOUTUM, Chicago, IL (US)

(21) Appl. No.: 18/010,738

(22) PCT Filed: Jun. 15, 2021
(86) PCT No.: PCT/US2021/037355

§ 371 Date: Dec. 15, 2022

Related U.S. Application Data
(60) Provisional application No. 63/039,718, filed on Jun. 16, 2020.

(51) Int. Cl. A23G 1/54; A23G 1/48; A23G 1/40; A23G 1/36; A23G 1/44; A23G 1/52

(52) U.S. Cl. CPC A23G 1/54; A23G 1/48; A23G 1/40; A23G 1/36; A23G 1/44; A23G 1/52

(57) ABSTRACT

Provided herein is a non-baked food product comprising a nougat composition, wherein the nougat composition comprises: chocolate liquor; cocoa powder; chocolate; and invert sugar. Further provided herein is a process for making said non-baked food product.

### FIELD OF THE INVENTION

The invention relates to a non-baked food product comprising a nougat composition and processes for preparing such products.

### BACKGROUND OF THE INVENTION

Non-baked food products can be prepared without baking or cooking. However, non-baked food products often lack the textural appeal of baked products.

Nougat is a popular confectionery item. Nougat may be available as a discrete product in itself. Alternatively, it is present as a component of composite confectionery items such as bars which comprise other elements such as chocolate, as well as caramels including aerated caramels, toffees, fudges, nuts, dried fruit, wafers, biscuits, gels, flavoured creams or pralines. Nougats traditionally comprise sugars, which may be in the form of honey, as well as egg white, which provides a source of protein. Some nougats are hard and chewy but softer nougats, sometimes called nougatines, contain higher moisture content. Nougats may also contain ingredients such as cocoa, milk powder, lactose, malt and icing sugar, which have a shortening effect. Fats and/or oils, and emulsifiers may also be included.

Typical nougat recipes are described for example in ‘Sugar Confectionery Manufacture’ (Berlin:Springer) Second edition, 1995 Ed. E. B. Jackson and in particular in Table 13.3 which shows some specific examples. Typically, nougat formulations comprise from about 60 to about 82% w/w (for example from about 67 to about 80% w/w) of a sugar syrup; from about 6 to about 32% w/w (for example from about 8 to about 25% w/w) of an egg mixture; and from about 5 to about 15% w/w (for example from about 10 to about 14% w/w) of a flavouring and graining mixture.

As described in US 2017/0245519A1, nougat is typically prepared by mixing together appropriate amounts of a sugar syrup and a protein mixture, aerating the mixture and thereafter mixing the resultant frappe with a suitable quantity of flavouring/graining mixture. Thus, the term “frappe” refers to an aerated or foamed mixture comprising sugars and proteins which has been stabilised by coagulation of proteins. This is used as a starting material for a range of products including nougat, but also meringue, fondant, cake, bavaroise or mousse.

As described in US 2017/0245519A1, frappe is typically prepared using a syrup solution prepared by mixing a sugar such as granulated sucrose with sufficient water to form a solution and the resultant sugar solution is formed into a ‘base syrup’ or ‘doctor syrup’ by addition of glucose and optionally other ingredients such as salt. It is then generally necessary to subject the base syrup to a heating or cooking procedure to remove at least some of the water before the syrup is of an appropriate concentration to go forward to the subsequent processing stages. Highly elevated temperatures, for example of up to 140° C., are generally required in order to evaporate water in order to reduce the water content in line with the recipe. On cooling, the resultant syrup forms a highly saturated solution which changes state during production to a crystalline form to obtain the desired texture properties.

U.S. Ser. No. 10/383,344 describes non-baked foodstuffs comprising at least one setting agent and at least one texture-modifying particulate ingredient.

There remains a desire in the art to provide non-baked foodstuffs which have the texture of baked foodstuffs and while retaining acceptable moisture content. In particular, there remains a desire to provide an unbaked brownie-type food product, which exhibits the soft texture of a moist baked brownie, and which also exhibits the rich taste characteristics of a baked brownie. Furthermore, there is a desire to provide a simpler, industrially scalable, cost-efficient process of making such non-baked foodstuffs.

### SUMMARY OF THE INVENTION

The inventors have formulated a nougat composition wherein crystallization is inhibited and moisture is retained, and which is suitable to prepare a non-baked food product that has a texture which is comparable with a baked food product.

Thus, in a first aspect, the present invention provides a non-baked food product comprising a nougat composition, wherein the nougat composition comprises:
chocolate liquor;
cocoa powder;
chocolate; and
invert sugar.

In a second aspect, the present invention provides a process for making a non-baked food product according to the first aspect comprising:
(a) preparing a base syrup comprising invert sugar;
(b) mixing the base syrup with a protein source (e.g. egg albumen powder) to form a protein syrup blend;
(c) aerating the protein syrup blend;
(d) preparing a slurry comprising chocolate liquor, cocoa powder and chocolate; and
(e) mixing the slurry with the aerated protein syrup blend to form a nougat composition.

### BRIEF DESCRIPTION OF THE FIGURES

FIGS. 1 and 2 are photographs of non-baked food products according to the present invention.

### DETAILED DESCRIPTION

As used herein, the term “non-baked” means that the food product is not subject to baking. The term “non-baked” is also referred to as “un-baked” or “no-bake”.

The non-baked food product has a baked texture without the need for baking. Baking is defined herein as cooking by dry heat (typically in an oven) at a temperature of at least 100° C., typically at least 130° C., more typically at least 150° C. A baking process dries and hardens a food composition to provide the final food product. Thus, the non-baked food product of the present invention is not subject to cooking by dry heat at the temperatures defined above. It will be appreciated that one or more ingredients of the non-baked food product may be prepared by a process which comprises heating at temperatures above 100° C. For instance, preparation of the base syrup is effected at temperatures above 100° C., as described below, and of course the processing of cocoa beans involves roasting at elevated temperatures. The food product of the present invention is categorized as non-baked because the nougat composition is not subject to a baking step once all the ingredients of the nougat composition have been combined.

Nougat Composition

The term “chocolate liquor” refers to the dark brown fluid “liquor” formed by grinding a cocoa nib. The fluidity is due to the breakdown in the cell walls and the release of the cocoa butter during the processing resulting in a suspension of ground particles of cocoa solids (i.e. cocoa powder) suspended in cocoa butter. The chocolate liquor can be prepared from unfermented or fermented cocoa beans. The chocolate liquor can be further processed by alkalization. Preferably, the chocolate liquor used herein is non-alkalized.

The chocolate liquor may include additional ingredients such as cocoa fat, alkali ingredients, neutralizing agents, spices, natural and artificial flavourings, ground whole nut meats, ground coffee, dried malted cereal extract, and other seasonings that do not either singly or in combination impart a flavour that imitates the flavour of chocolate, milk (including milk fat), butter, or salt. Suitable alkali agents are ammonium bicarbonate, ammonium carbonate, ammonium hydroxide, potassium bicarbonate, potassium carbonate, potassium hydroxide, sodium bicarbonate, sodium carbonate, sodium hydroxide, magnesium carbonate, magnesium oxide and combinations thereof. The alkali agent may be added as a solid or as an aqueous solution. Suitable neutralizing ingredients are phosphoric acid, citric acid, L-tartaric acid and combinations thereof. The neutralizing agent may be added as a solid or as an aqueous solution.

The term “chocolate liquor” may also be referred to as “chocolate”, “unsweetened chocolate”, “bitter chocolate”, “baking chocolate”, “cooking chocolate”, “chocolate coating”, or “unsweetened chocolate coating” in the art.

The non-baked food product according to the present invention comprises from about 0.5 to about 10 wt %, preferably from about 1 to about 8 wt %, preferably from about 1.5 to about 6 wt % chocolate liquor, by total weight of the non-baked food product.

Preferably, the nougat composition comprises from about 1 to about 15 wt %, preferably from 3 to about 12 wt %, preferably from about 5 to about 10 wt % chocolate liquor, by total weight of the Any type of cocoa powder can be used in the present invention, for example, red cocoa powder, natural cocoa powder, sienna cocoa powder or black cocoa powder. Preferably the cocoa powder is black cocoa powder. The term “black cocoa powder” refers to alkalized cocoa powder and is also referred to in the art as “Dutched” or “Dutch” cocoa powder. As will be appreciated by those skilled in the art, alkalization (also referred to as “alkalizing”) involves the addition of an alkalizing salt to the cocoa beans or products derived therefrom (i.e. cocoa nibs, cocoa liquor or cocoa cake). The alkalizing salt may be selected from ammonium, calcium, magnesium, potassium or sodium carbonate, ammonium, potassium or sodium bicarbonate, ammonium, calcium, magnesium, potassium or sodium hydroxide, magnesium oxide or any combination thereof. Preferably, the alkalizing agent used herein is calcium carbonate.

Black cocoa powder has a darker colour than cocoa powders derived without alkalization. One way to measure the degree of lightness or darkness of cocoa powder is by using the Hunter “L” scale value. The Hunter L scale was designed to give measurements of colour units of approximate visual uniformity. Thus “L” measures lightness and varies for 0 for pure black to 100 for pure white. Commercial deep red cocoa powders typically have an “L” value of 19 to 24. The colour scales are described more fully in Hunter, R. S., The Measurement of Appearance, John Wiley and Sons, New York, 1975.

The non-baked food product according to the present invention comprises from about 0.1 to about 8 wt %, preferably from about 0.2 to about 6 wt %, preferably from about 0.3 to about 4 wt % cocoa powder, by total weight of the non-baked food product.

Preferably, the nougat composition comprises from about 0.5 to about 10 wt %, preferably from 1 to about 8 wt %, preferably from about 1.5 to about 6 wt % cocoa powder, by total weight of the nougat composition.

Preferably, the non-baked food product according to the present invention comprises from about 1 to about 15 wt %, preferably from about 3 to about 12 wt %, preferably from about 5 to about 10 wt % chocolate, by total weight of the non-baked food product.

Preferably, the chocolate is alkalized dark chocolate. Preferably, the non-baked food product according to the present invention comprises from about 0.1 to about 8 wt %, preferably from about 0.2 to about 6 wt %, preferably from about 0.3 to about 4 wt % alkalized dark chocolate by total weight of the non-baked food product.

Preferably, the nougat composition comprises from about 3 to about 20 wt %, preferably from 5 to about 18 wt %, preferably from about 8 to about 15 wt % chocolate, by total weight of the nougat composition. Preferably, the chocolate is alkalized dark chocolate. Preferably, the nougat composition comprises from about 0.5 to about 12 wt %, preferably from 1 to about 10 wt %, preferably from about 1.5 to about 8 wt % alkalized dark chocolate, by total weight of the nougat composition.

The term “invert sugar” (also referred to as inverted sugar or invert syrup) is an aqueous solution of inverted, refined or partly refined sucrose, the solids of which contain no more than 0.3 wt % of ash. Typically, it is prepared by the hydrolysis of sucrose into glucose and fructose using a glycoside hydrolase enzyme invertase or an equivalent enzyme (enzymatic conversion), or an appropriate acid (acid conversion), or heat (thermal hydrolysis) which splits each sucrose disaccharide molecule into its component glucose and fructose monomer molecules. Without wishing to be bound in this regard, it is believed that the addition of invert sugar inhibits crystallization of the nougat and promotes moisture retention and a soft baked-like texture without the need for baking.

Typically, the invert sugar used herein is a mixture of from about 25 to about 75 wt % of glucose, from about 25 to about 75 wt % of fructose and preferably comprises less than 5 wt % of sucrose. Preferably, the invert sugar is about a 50:50 w/w mixture of fructose and glucose. Preferably the invert sugar contains from about 65% to about 85% by weight solids, more preferably from about 70% to about 80% by weight solids, more preferably from about 72% to about 78% by weight solids.

The non-baked food product according to the present invention comprises from about 0.1 to about 8 wt %, preferably from about 0.2 to about 6 wt %, preferably 0.3 to about 4 wt % invert sugar, by total weight of the non-baked food product.

The nougat composition preferably comprises from about 0.5 to about 10 wt %, preferably from 1 to about 8 wt %, preferably from about 1.5 to about 6 wt % invert sugar, by total weight of the The nougat composition according to the present invention may further comprise water. Water is added in order to provide the final moisture level in the final product. The amount of water added will vary depending on the nature of the food product. For a confectionery product, such as a brownie, the moisture content will typically be in the range of from about 1 to about 30 wt %, preferably from about 3 to about 25 wt %, preferably from about 5 to about 20 wt %, by total weight of the non-baked food product.

Preferably, the moisture content is from about 2 to about 12 wt %, preferably from about 3 to about 10 wt %, preferably from about 5 to about 7 wt % by total weight of the nougat composition.

The non-baked food product according to the present invention has a water activity of greater than about 0.55, preferably greater than about 0.8. The water activity (Aw) is defined as follows:

Aw=P/P₀

where P is the partial pressure of water in the food product at temperature T and P₀ is the saturated water pressure of pure water at the given temperature T. The water activity is measured using an Aqualab Series TE DUO 4 machine (Decagon Devices, Inc., USA). The calibration of the instrument was performed using 8.57 M LiCl solution.

The nougat composition according to the present invention may also include one or more additional sweetener(s) such as a nutritive carbohydrate sweetener. Nutritive carbohydrate sweeteners are well known in the art and include sucrose, e.g. from cane or beet, dextrose, fructose, lactose, maltose, glucose syrup, corn syrup, hydrolyzed lactose, honey, maple sugar, brown sugar, molasses and the like. Glucose syrup and corn syrup can be added in the form of solids, i.e. glucose syrup solids and corn syrup solids. Preferably, the nutritive carbohydrate sweetener is sucrose. Preferably, the sucrose is used as liquid sucrose (i.e. an aqueous solution of sucrose). Preferably, the sucrose is used in combination with corn syrup.

When present, the one or more additional sweetener(s) is generally in an amount of from about 5 to about 45 wt %, preferably from about 10 to about 40 wt %, by total weight of the non-baked food product.

When the additional sweetener includes sucrose, it is preferably included in an amount of from about 5 to about 30 wt %, preferably from about 10 to about 25 wt %, by total weight of the non-baked food product. When the additional sweetener includes corn syrup it is preferably included in an amount of from about 5 to about 30 wt %, preferably from about 8 to about 25 wt %, by total weight of the non-baked food product. When the sweetener includes a combination of sucrose and corn syrup they are preferably included in a combined amount of from about 5 to about 45 wt %, preferably from about 10 to about 40 wt %, by total weight of the non-baked food product.

Preferably, the nougat composition comprises from about 10 to about 50 wt %, preferably from about 15 to about 40 wt %, preferably from about 20 to about 30 wt % sucrose, by total weight of the nougat composition. Preferably, the nougat composition comprises from about 5 to about 45 wt %, preferably from about 10 to about 35 wt %, preferably from about 15 to about 25 wt % corn syrup, by total weight of the nougat composition.

The nougat composition according to the present invention may also include a sugar substitute (also referred to as a sugar replacer). The term “sugar substitute” includes bulking agents, sugar alcohols (polyols such as glycerol), high potency sweeteners or combinations thereof. Sugar substitutes may partially replace the nutritive carbohydrate sweetener.

The term “bulking agents” as defined herein may be any of those typically used in the art and includes polydextrose, polyfructose (inulin), other oligosaccharides, cellulose and its derivatives, maltodextrin, gum arabic, starches and modified food starches, and the like. High potency sweeteners include aspartame, neotame, cyclamates, saccharin, acesulfame potassium, neohesperidin dihydrochalcone, sucralose, alitame, stevia sweeteners, glycyrrhizin, thaumatin, isomalt and the like and mixtures thereof. Examples of sugar alcohols may be any of those typically used in the art and include sorbitol, mannitol, xylitol, maltitol, isomalt, lactitol and the like.

The nougat composition of the present invention may also contain a protein source such as a milk protein or egg albumen. Preferably, the protein source is egg albumen powder. Preferably, the protein source is present in an amount of up to about 5 wt %, preferably up to about 4 wt %, more preferably up to about 3 wt % of the total non-baked food product. Preferably, the protein source is egg albumen powder in an amount of up to about 5 wt %, preferably up to about 4 wt %, more preferably up to about 3 wt % of the total non-baked food product.

Preferably, the protein source is present in an amount of up to about 3 wt %, preferably up to about 2 wt %, preferably up to about 1 wt % of the nougat composition.

The nougat composition of the present invention may also contain other optional ingredients such as one or more emulsifier(s), one or more stabilizer(s), one or more thickener(s), one or more foaming agent(s), one or more humectant(s), one or more addition fat(s) and/or oil(s), one or more antioxidant(s) and/or one or more flavourant(s).

Examples of safe and suitable emulsifiers may be any of those typically used in the art or having GRAS (“Generally Recognized As Safe”) status, and include lecithin derived from vegetable sources such as soybean, safflower, corn, etc., fractionated lecithins enriched in either phosphatidyl choline or phosphatidyl ethanolamine or both, mono- and digylcerides, diacetyl tartaric acid esters of mono- and diglycerides (also referred to as DATEM), monosodium phosphate derivatives of mono- and diglycerides of edible fats or oils, sorbitan monostearate, hydroxylated lecithin, lactylated fatty acid esters of glycerol and propylene glycol, polyglycerol esters of fatty acids (e.g., polyglycerol ricinoleate (PGPR)), propylene glycol mono- and diester of fats and fatty acids, or any emulsifier that may become approved for the USFDA defined soft candy category. In addition, other emulsifiers that can be used in the present invention, include polyglycerol polyricinoleate, ammonium salts of phosphatidic acid, sucrose esters, oat extract, any emulsifier found to be suitable in chocolate or a similar fat/solid system, or any blend of these. Emulsifiers preferred for use in the present invention are lecithin, fractionated lecithin, diacetyl tartaric acid esters of mono- and diglycerides (DATEM) or mixtures of these emulsifiers. A particularly preferred emulsifier is lecithin.

Typically, an emulsifier may be included in the nougat composition in up to about 2.5 wt %, by total weight of the non-baked food product, subject to local regulations and achievement of the desired functionality.

Exemplary fats and/oils that can be used herein include naturally occurring fats and oils such as canola oil, cocoa butter, pressed cocoa butter, expeller cocoa butter, solvent extracted cocoa butter, refined cocoa butter, coconut oil, copra oil, cotton oil, cottonseed oil, olive oil, palm oil, palm kernel oil, peanut oil, sunflower oil, soybean oil, milkfat, anhydrous milkfat, fractionated milkfat, milkfat replacers, butterfat, fractionated butterfat, cocoa butter equivalents, cocoa butter improvers, cocoa butter substitutes, cocoa butter replacers, reduced calorie fats, synthetically modified fats such as Caprenin® and/or combinations thereof. In some embodiments, the fat may be chemically modified (i.e. hydrogenated or interesterified). Preferably, the fat used herein is a vegetable oil, more preferably the vegetable oil is selected from, palm oil, hydrogenated palm kernel oil, hydrogenated rapeseed oil and combinations thereof. Preferably, the vegetable oil is used in combination with cocoa butter. Chocolate (for instance alkalized dark chocolate) may also be used as a fat source.

Typically one or more fat(s) and/or oil(s) may be included in up to about 8 wt %, preferably up to about 5 wt %, by total weight of the non-baked food product.

Exemplary humectants that may be used include salt, propylene glycol, hexylene glycol, butylene glycol, honey, palm oil, molasses, polymeric polyols such as polydextrose, sugar alcohols such as glycerol, sorbitol, xylitol, maltitol, castor oil, glucose syrup, corn syrup egg yolk, egg white (i.e. egg albumen), alpha hydroxyl acids such as lactic acid and combinations thereof.

An antioxidant may be used to maintain freshness of the non-baked food product. Exemplary antioxidants that can be used herein include lecithin, butylated hydroxyanisole, butylated hydroxytoluene, tertiary butylated hydroquinone, propyl gallate, a phenolic acid, a polyphenol, ascorbic acid, stannous chloride, a tocopherol, sulfur dioxide, dilauryl thiodipropionate, and mixtures thereof. Preferably, the antioxidant is tertiary butylhydroquinone.

When present, the antioxidant is present in up to about 1 wt % of the non-product composition.

The nougat may also comprise one or more colorants and/or flavour enhancers such as monohydrate lactose (for instance alpha monohydrate lactose), salt or calcium carbonate.

Coating Layer

The non-baked food product according to the present invention preferably further comprises a coating layer. Preferably the coating layer is an enrobing layer which covers or encapsulates the nougat. Enrobing processes are well known in the art.

Preferably, the coating layer comprises milk chocolate, dark chocolate (including alkalized dark chocolate), white chocolate or a combination thereof. The coating layer may also contain other optional ingredients such as one or more sweeteners, one or more emulsifier(s), one or more stabilizer(s), one or more thickener(s), one or more foaming agent(s), one or more humectant(s), one or more addition fat(s) and/or oil(s), one or more antioxidant(s) and/or one or more flavourant(s). Such additional ingredients are as described above in relation to the nougat composition.

Preferably the coating is a chocolate coating wherein the chocolate comprises the following ingredients:

| Ingredient | Amount (wt %) |
|---|---|
| Sugar | 40-50, typically 44-48, for instance about 46 |
| Whole milk powder | 20-27, typically 22-25, for instance about 23 |
| Cocoa liquor | 8-15, typically 9-13, for instance about 11 |
| Cocoa butter | 15-25, typically 17-21, for instance about 19 |
| Lecithin | 0.1-1, typically 0.3-0.8, for instance about 0.5 |
| Vanillin | 0.01-0.01, typically 0.01-0.05, typically 0.03 |

The chocolate coating is suitably prepared according to the following process. All dry ingredients and the cocoa butter fat are heated at 45° C. for 3 mins. After mixing, the resulting paste is passed through a two roller refiner and a five rover refiner to produce flakes with particle sizes ranging between 50 and 55 microns, After refining, the mixture comprising the refined mass is mixed with the rest of the fat and lecithin to liquefy it at 45° C. for 3 mins.

Caramel Layer

The non-baked food product according to the present invention preferably further comprises a caramel layer. Preferably, the caramel comprises a solid plant-derived fat and an amount of water less than about 10 wt %, preferably less than about 5 wt %. Typically, the solid plant-derived fat is present in an amount of from about 8 wt % to about 20 wt %, preferably from about 10 wt % to about 18 wt %, and more preferably from about 12 wt % to about 16 wt %, based upon the total weight of the caramel.

The solid plant-derived fat preferably has a Mettler Drop Point melting point of from about 35° C. to about 50° C., or from about 40° C. to about 45° C. The solids content of the solid plant-derived fat is from 70% to 80% at 10° C., or from 50% to 60% at 20° C., or both.

Without wishing to be bound in this regard, the plant-derived fat suitably acts as a texturing agent. Suitable plant fats include palm oil, kernel oil, cocoa butter and combinations thereof. Preferably, the caramel comprises palm oil. Preferably, the palm oil is present in an amount of from about 5 to about 30 wt %, preferably from about 8 to about 25 wt %, preferably from about 10 to about 20 wt % of the total weight of caramel. Preferably, the palm oil is present in an amount of up to about 5 wt %, preferably up to about 4 wt %, preferably up to about 3 wt % of the total non-baked food product.

The caramel may further comprise a sweetener such as corn syrup (for example 63 DE corn syrup) or a corn syrup blend (for example, from 40:60 to 60:40 of 42 DE and 63 DE corn syrup). Preferably, the corn syrup is present in an amount of from about 30 to about 60 wt %, preferably from about 35 to about 55 wt %, preferably from about 40 to about 50 wt % based on the total weight of the caramel. Without wishing to be bound in this regard, the corn syrup may also facilitate browning of the caramel and/or structure the caramel.

The caramel may further comprise a milk mix. Preferably the milk mix comprises sweetened condensed milk, liquid sucrose, lactose monohydrate (for example lactose alpha monohydrate), salt and vanillin. Without wishing to be bound in this regard, the milk mix adds protein to the caramel, enhances flavour, colour and/or structure.

A monosaccharide may also be used in the caramel, preferably in an amount of from about 2 to 5 wt % based on the total weight of the caramel. Any monosaccharide may be included, such as dextrose, fructose, galactose, polymeric forms of these, anhydrous forms of these, hydrates of these, or combinations of these. Preferably, the monosaccharide is dextrose. The caramel may further include a polyol, such as sorbitol, glycerin, hydrogenated starch hydrolysates, hydrogenated isomaltose, maltitol, mannitol, xylitol, erythritol, or a combination of these. Preferably, the caramel may comprise glycerin.

The caramel layer may also contain other optional ingredients such as one or more additional sweeteners, one or more emulsifier(s), one or more stabilizer(s), one or more thickener(s), one or more foaming agent(s), one or more humectant(s), one or more addition fat(s) and/or oil(s), one or more antioxidant(s) and/or one or more flavourant(s). Such additional ingredients are as described above in relation to the nougat composition.

Preferably, the moisture content of the caramel is from about 1 to about 25 wt %, preferably from about 5 to about 20 wt %, preferably from about 8 to about 15 wt % of the total weight of the caramel.

Due at least in part to the low moisture content and the properties of the solid plant-derived fat, the caramel is readily deposited on the nougat component during manufacture and exhibits desirable organoleptic properties upon consumption. Also, due at least in part to the low moisture content of the caramel, a barrier layer is not required between the nougat component and the caramel, as is conventional, although a barrier may be used in embodiments wherein an extended shelf life is anticipated. If a barrier layer is utilized, it may comprise hydrogenated fat, crème, whey protein, ethyl cellulose, pullulan, or a combination of these and will preferably comprise an amount of water less than the caramel filling.

Food Product

The non-baked food product according to the present invention is preferably a confectionery product, preferably a brownie.

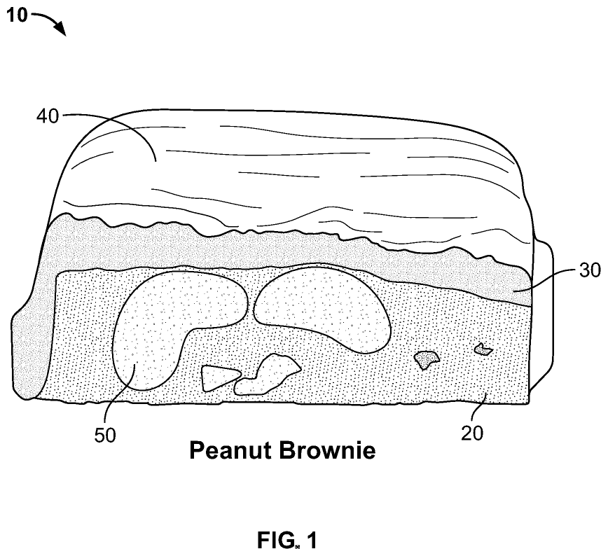

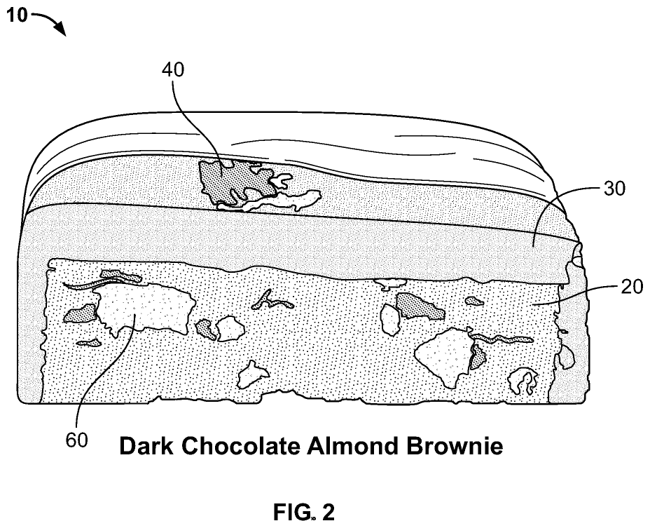

A brownie product according to the present invention is shown in FIGS. 1 and 2. The brownie (10) comprises a nougat centre (20), a caramel layer (30) and a chocolate enrobing (40). Preferably, as illustrated in FIG. 1, the brownie (10) comprises peanuts (50) in the nougat centre (20). Preferably, as illustrated in FIG. 2, the brownie (10) comprises almonds (60) in the nougat centre.

The non-baked food product according to the present invention preferably comprises the nougat composition described herein in an amount of from about 30 to 50 wt %, preferably from about 35 to 45 wt %, preferably from about 38 to 40 wt %, by total weight of the food product.

The non-baked food product according to the present invention preferably comprises the coating layer described herein in an amount of from about 20 to 50 wt %, preferably from about 25 to 40% wt, preferably about 35 wt % by total weight of the food product.

The non-baked food product according to the present invention preferably comprises the caramel layer described herein in an amount of from about 10 to 20 wt %, preferably from about 12 to 15 wt %, preferably about 15 wt % by total weight of the food product.

The non-baked food product preferably comprises from about 30 to 50 wt % nougat composition, from about 20 to 50 wt % coating layer and from about 10 to 20 wt % coating later; preferably from about 35 to 45 wt % nougat composition, from about 25 to 40 wt % coating layer and from about 12 to 15 wt % coating later; most preferably from about 38 to 40 wt % nougat composition, about 35 wt % coating layer and from about 15 wt % coating later.

The non-baked food product according to the present invention may also include various additional filings in the nougat composition such as nuts, chocolate chips, marshmallows, toffees, fudges, caramels wafers, biscuits and dried fruits. Preferably, the additional filling is a type of nut, for example peanuts, almonds, walnuts, pecans, pistachios, hazelnuts, cashew nuts, macadamia nuts, Brazil nuts or a combination thereof. Preferably, the additional filling is peanuts or almonds.

When present, the additional filling is present in an amount of from about 5 to 20 wt % of the non-baked food product, preferably from about 10 to 15 wt % of the non-baked food product, preferably about 12 wt % of the non-baked food product. Preferably, the additional filling is peanuts and the peanuts are present in amount of from about 5 to 20 wt % of the non-baked food product, preferably from about 10 to 15 wt % of the non-baked food product, preferably about 12 wt % of the non-baked food product. Preferably, the additional filling is almonds and the almonds are present in amount of from about 5 to 20 wt % of the non-baked food product, preferably from about 10 to 15 wt % of the non-baked food product, preferably about 12 wt % of the non-baked food product.

The food product may have dimensions typical for a confectionary product, and preferably has dimensions appropriate for a brownie. For example, the longest dimension may be from about 40 to about 60 mm. The width may be from about 20 to about 60 mm, and in a preferred embodiment for the brownie, the food product is square with both the length and width dimensions from about 40 to about 60 mm. The height of the brownie is preferably from about 5 to about 25 mm.

Preferably, the nougat composition and caramel layer are enrobed or encapsulated with the coating layer. When the coating layer encapsulates the nougat and caramel it may not have the same thickness on each outer surface of the food product.

Preferably, the caramel layer is between the nougat and the coating layer. Preferably the caramel layer is thinner than the nougat layer. Preferably, the thickness of the caramel layer is from about 15 to about 35% of the thickness of the nougat layer.

Advantageously, the non-baked food product according to the present invention exhibits a reduced sugar content compared with conventional confectionary products which contain chocolate and nuts and which are currently commercially available. Preferably, the non-baked food product according to the present invention has at least 2 wt % less sugar, preferably at least 3 wt % less sugar, preferably at least 5 wt % less sugar compared with such a conventional confectionary product containing chocolate and nuts.

Advantageously, the non-baked food product according to the present invention exhibits a softer texture compared with conventional confectionary products which contain chocolate and nuts and which are currently commercially available.

Method

The nougat composition of the present invention is prepared by a process comprising:
(a) preparing a base syrup comprising invert sugar;
(b) mixing the base syrup with a protein source (e.g. egg albumen powder) to form a protein syrup blend;
(c) aerating the protein syrup blend;
(d) preparing a slurry comprising chocolate liquor, cocoa powder and chocolate; and
(e) mixing the slurry with the aerated protein syrup blend to form a nougat composition.

Typically, a base syrup is prepared from invert sugar, corn syrup, liquid sucrose and salt. Typically, the base syrup is prepared by mixing the ingredients and heating them, suitably at a temperature in the range of from about 90 to 150° C., preferably from about 110 to about 130° C.

The base sugar syrup is then blended with a protein source (e.g. egg albumen powder) to form a protein syrup blend, which is further blended with water. The resulting mixture is heated and aerated under conditions sufficient to form a frappe, as well-known in the art. Aeration may be conducted at atmospheric or elevated pressure, depending on the equipment used. Preferably, aeration is conducted at a pressure in the range of 1 to 5 bar. Without wishing to be bound in this regard, the egg albumen may be considered as an aerating agent.

Preferably, a slurry is prepared by mixing chocolate liquor, cocoa powder and chocolate. The slurry is then combined with the frappe to form the nougat composition.

The caramel may be prepared by any known method. Typically, the process entails mixing the corn syrup, milk mix and palm oil in a heating vessel and heating under conditions sufficient to achieve caramelization. Once formed, the caramel is deposited on the nougat composition. For example, the caramel may form a layer on one side of the nougat composition.

The nougat composition and caramel layer are then shaped into the desired dimensions. After cooling, the shaped product is enrobed with chocolate.

Advantageously, the process according to the present invention provides a convenient and energy-efficient process for preparing non-baked food products having a texture similar to baked food products without the need for baking.

The present invention is further illustrated with reference to the following non-limiting examples.

### EXAMPLES

### Example 1: Preparation of Nougat Composition

A base syrup was prepared using the following components:

| Ingredient | Amount (% weight of the base syrup) |
|---|---|
| Corn Syrup | 38-41% |
| Invert sugar | 7.5-9.5% |
| Sucrose | 33-38% |
| Water | 15-18% |
| Salt | 0.5-2.5% |

The components listed above were mixed and heated until an even suspension was formed. The resulting base syrup was then blended with egg albumen powder to form an egg syrup blend wherein the egg albumen powder was added in an amount sufficient to form an egg syrup blend comprising 10 wt % egg albumen powder in the egg syrup blend. The egg syrup blend was then further blended with water. The egg syrup blend and water mixture were then heated and aerated under conditions sufficient to form a frappe.

A flavouring slurry was prepared from the following ingredients:

| | Amount (% weight of the flavouring |
|---|---|
| Ingredient | slurry) |
| Chocolate liquor | 32-36% |
| Chocolate | 48-53% |
| Cocoa powder | 12-18% |

The flavouring slurry was mixed with the frappe and peanuts to produce the nougat composition according to the table below.

| | Amount (% weight of the nougat |
|---|---|
| Ingredient | composition) |
| Frappe | 48-52% |
| Peanuts | 22-25% |
| Slurry | 25-28% |

### Example 2: Preparation of a Non-Baked Brownie

The nougat composition prepared in Example 1 was formulated into a non-baked brownie by addition of a caramel and chocolate coating layer in the amounts indicated in the table below.

| | Amount (% of the non-baked brownie |
|---|---|
| Ingredient | product) |
| Nougat Composition | 48-52% |
| Caramel | 10-15% |
| Chocolate coating | 32-38% |

The resulting non-baked brownie is shown in FIG. 1. The non-baked brownie provided a rich chocolate taste indicative of a baked brownie.

1. A non-baked food product comprising a nougat composition, wherein the nougat composition comprises:
chocolate liquor;
cocoa powder;
chocolate; and
invert sugar.

2. The non-baked food product according to claim 1 wherein the cocoa powder is black cocoa powder.

3. The non-baked food product according to claim 1 wherein the chocolate is alkalized dark chocolate.

4. The non-baked food product according to claim 1 wherein the chocolate liquor is present in an amount of from about 0.5 to about 10 wt % of the non-baked food product, preferably from about 1 to about 8 wt % of the non-baked food product, preferably from about 1.5 to about 6 wt % of the non-baked food product.

5. The non-baked food product according to claim 1 wherein the cocoa powder is present in an amount of from about 0.1 to about 8 wt % of the non-baked food product, preferably from about 0.2 to about 6 wt % of the non-baked food product, more preferably from about 0.3 to about 4 wt % of the non-baked food product.

6. The non-baked food product according to claim 1 wherein the chocolate is present in an amount of from about 1 to about 15 wt % of the non-baked food product, preferably from about 3 to about 12 wt % of the non-baked food product, more preferably from about 5 to about 10 wt % of the non-baked food product.

7. The non-baked food product according to claim 1 wherein the invert sugar is present in an amount of from about 0.1 to about 8 wt % of the non-baked food product, preferably from about 0.2 to about 6 wt % of the non-baked food product, more preferably from about 0.3 to about 4 wt % of the non-baked food product.

8. The non-baked food product according to claim 1 wherein the chocolate liquor is present in an amount of from about 0.5 to about 10 wt % of the non-baked food product, the cocoa powder and invert sugar are present in an amount of from about 0.1 to about 8 wt % of the non-baked food product and the chocolate is present in an amount of about 1 to about 15 wt % of the non-baked food product; preferably wherein the chocolate liquor is present in an amount of from about 1 to about 8 wt % of the non-baked food product, the cocoa powder and invert sugar are present in an amount of from about 0.2 to about 6 wt % of the non-baked food product and the chocolate is present in an amount of about 3 to about 12 wt % of the non-baked food product; more preferably wherein the chocolate liquor is present in an amount of from about 1.5 to about 6 wt % of the non-baked food product, the cocoa powder and invert sugar are present in an amount of from about 0.3 to about 4 wt % of the non-baked food product and the chocolate is present in an amount of from about 5 to about 10 wt % of the non-baked food product.

9. The non-baked food product according to claim 1 further comprising a coating layer, preferably an enrobing layer which covers or encapsulates the nougat.

10. The non-baked food product according to claim 1 further comprising a caramel layer, preferably wherein said caramel layer is positioned between the nougat and the coating layer.

11. The non-baked food product according to claim 1 wherein the nougat further comprises water, one or more additional sweetener(s), one or more additional fat(s) and/or oil(s), a thickener, a humectant, an antioxidant, a colourant and/or a flavourant.

12. The non-baked food product according to claim 11 wherein said one or more additional sweetener(s) is selected from the group consisting of sucrose, corn syrup, lactose, dextrose, glycerol and combinations thereof.

13. The non-baked food product according to claim 11 wherein said one or more additional fat(s) and/or oil(s) is selected from the group consisting of cocoa butter, milk fat, palm oil, hydrogenated palm kernel oil, hydrogenated cottonseed oil, hydrogenated rapeseed oil and combinations thereof.

14. The non-baked food product according to claim 9 wherein the coating layer is selected from the group consisting of white chocolate, dark chocolate, milk chocolate and combinations thereof.

15. The non-baked food product according to claim 1 further comprising almonds, peanuts and combinations thereof.

16. The non-baked food product according to claim 15 wherein the almonds are present in an amount of from about 5 to about 20 wt % of the non-baked food product, preferably from about 8 to about 15 wt % of the non-baked food product, preferably about 10 wt % of the non-baked food product.

17. The non-baked food product according to claim 15 wherein the peanuts are present in an amount of from about 5 to about 20 wt % of the non-baked food product, preferably from about 10 to about 15 wt % of the non-baked food product, preferably about 12 wt % of the non-baked food product.

18. The non-baked food product according to claim 1 wherein the nougat composition is present in an amount of from about 30 to about 50 wt % of the non-baked food product, preferably from about 35 to about 45 wt % of the non-baked food product, preferably from about 38 to about 40 wt % of the non-baked food product.

19. The non-baked food product according to claim 9 wherein the coating layer is present in an amount of from about 20 to about 50 wt % of the non-baked food product, preferably from about 25 to about 40 wt % of the non-baked food product, preferably about 35 wt % of the non-baked food product.

20. The non-baked food product according to claim 10 wherein the caramel is present in an amount of from about 10 to about 20 wt % of the non-baked food product, preferably from about 12 to about 15 wt % of the non-baked food product, preferably about 15 wt % of the non-baked food product.

21. The non-baked food product according to claim 1 wherein the nougat composition has a moisture content of from about 1 to about 30 wt %, preferably from about 3 to about 25 wt %, preferably from about 5 to about 20 wt %, by total weight of the non-baked food product.

22. The non-baked food product of claim 1 wherein the food product is a brownie.

23. A process for making the non-baked food product according to claim 1 comprising:
(a) preparing a base syrup comprising invert sugar;
(b) mixing the base syrup with a protein source (e.g. egg albumen powder) to form a protein syrup blend;
(c) aerating the protein syrup blend;
(d) preparing a slurry comprising chocolate liquor, cocoa powder and chocolate; and
(e) mixing the slurry with the aerated protein syrup blend to form a nougat composition.

24. The process according to claim 23 comprising mixing nuts into the slurry prepared in step (d) or as part of step (e).

25. The process according to claim 23 further comprising forming a caramel layer and layering the caramel layer on top of the nougat.

26. The process according to claim 23 further comprising an enrobing step.
